(19) United States
(12) Patent Application Publication
(10) Pub. No.: US 2025/0200673 A1
(43) Pub. Date: Jun. 19, 2025

(54) DIALOG ABILITY ENHANCEMENT ASSISTANCE DEVICE, DIALOG ABILITY ENHANCEMENT ASSISTANCE CONTROL METHOD, AND NON-TRANSITORY RECORDING MEDIUM

(71) Applicant: NEC Corporation, Tokyo (JP)

(72) Inventors: Shinnosuke NISHIMOTO, Tokyo (JP); Kenichi UEDA, Tokyo (JP); Tsuyoshi NAKAMURA, Tokyo (JP); Yuki KOBAYASHI, Tokyo (JP)

(73) Assignee: NEC Corporation, Tokyo (JP)

(21) Appl. No.: 18/954,896

(22) Filed: Nov. 21, 2024

(30) Foreign Application Priority Data
Dec. 15, 2023 (JP) 2023-212053

(51) Int. Cl. G06Q 50/00

(52) U.S. Cl. CPC G06Q 50/01

(57) ABSTRACT

A dialog ability enhancement assistance device 30 includes a reception unit 31 that receives information for selecting a scene 312 in which participants including a user and one or more machine learning models 311 have a dialog with each other, and the machine learning models 311 included in the participants, a construction unit 32 that constructs an environment 321 in which the participants have a dialog with each other in the selected scene 312, an acquisition unit 33 that acquires dialog content 331 between the user and the machine learning models 311 in the environment 321, and an evaluation unit 34 that evaluates, based on an evaluation criterion 341 for evaluating a dialog ability according to the dialog content 331, the dialog ability of the user from the acquired dialog content 331.

This application is based upon and claims the benefit of priority from Japanese Patent Application No. 2023-212053, filed on Dec. 15, 2023, the disclosure of which is incorporated herein in its entirety by reference.

### TECHNICAL FIELD

The present disclosure relates to a dialog ability enhancement assistance device, a dialog ability enhancement assistance control method, and a non-transitory recording medium.

### BACKGROUND ART

Reference literature (JP 2022-000807 A) discloses a system that promotes health, learning, and purchase of a user through a dialog that makes the user feel as if he/she is in contact with one person who cares about his/her own body using the system. This system analyzes a mental state of a user from content or the like that the user has uttered in a social networking service (SNS), and gives advice to the user through the SNS based on an analysis result.

It cannot be said that the technology described in the reference literature is sufficient for solving the enhancement of the user's dialog ability assuming various dialog scenes.

### SUMMARY

A main object of the present disclosure is to support enhancement of a user's dialog ability assuming various dialog scenes.

A dialog ability enhancement assistance device according to an aspect of the present disclosure includes one or more memories storing instructions, and one or more processors configured to execute the instructions to, receive information for selecting a scene in which participants including a user and one or more machine learning models have a dialog with each other, and the machine learning models included in the participants, construct an environment in which the participants have a dialog with each other in the selected scene, acquire dialog content between the user and the machine learning models in the environment, and evaluate, based on an evaluation criterion for evaluating a dialog ability according to the dialog content, the dialog ability of the user from the acquired dialog content.

From another viewpoint of achieving the above object, in a dialog ability enhancement assistance control method according to an aspect of the present disclosure executed by an information processing device, the method includes receiving information for selecting a scene in which participants including a user and one or more machine learning models have a dialog with each other, and the machine learning models included in the participants, constructing an environment in which the participants have a dialog with each other in the selected scene, acquiring dialog content between the user and the machine learning models in the environment, and evaluating, based on an evaluation criterion for evaluating a dialog ability according to the dialog content, the dialog ability of the user from the acquired dialog content.

From a further viewpoint of achieving the above object, in a non-transitory recording medium according to an aspect of the present disclosure, the non-transitory recording medium records a computer program for causing a computer to execute a reception step of receiving information for selecting a scene in which participants including a user and one or more machine learning models have a dialog with each other, and the machine learning models included in the participants, a construction step of constructing an environment in which the participants have a dialog with each other in the selected scene, an acquisition step of acquiring dialog content between the user and the machine learning models in the environment, and an evaluation step of evaluating, based on an evaluation criterion for evaluating a dialog ability according to the dialog content, the dialog ability of the user from the acquired dialog content.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of a dialog ability enhancement assistance device 10 according to the present disclosure;

FIG. 2 is a diagram illustrating the content of scene management information 181 in the dialog ability enhancement assistance device 10 according to the present disclosure;

FIG. 3 is a diagram illustrating the content of machine learning model management information 182 in the dialog ability enhancement assistance device 10 according to the present disclosure;

FIG. 4 is a diagram illustrating a first example of dialog content 184 in the dialog ability enhancement assistance device 10 according to the present disclosure;

FIG. 5 is a diagram illustrating an example of an evaluation result 186 in the dialog ability enhancement assistance device 10 according to the present disclosure;

FIG. 6A is a diagram (1/2) illustrating a second example of the dialog content 184 in the dialog ability enhancement assistance device 10 according to the present disclosure;

FIG. 6B is a diagram (2/2) illustrating the second example of the dialog content 184 in the dialog ability enhancement assistance device 10 according to the present disclosure;

FIG. 7 is a diagram illustrating input/output related to a machine learning model in the dialog ability enhancement assistance device 10 according to the present disclosure;

FIG. 8 is a diagram illustrating an example of a first request and a first answer in FIG. 7;

FIG. 9A is a diagram illustrating an example of a case where an additional question (second request) is input by the user in the state illustrated in FIG. 8;

FIG. 9B is a diagram illustrating an example of a second answer from the machine learning model to the second request illustrated in FIG. 9A;

FIG. 10 is a diagram illustrating input/output related to a machine learning model in an intervention function related to the machine learning model in the dialog ability enhancement assistance device 10 according to the present disclosure;

FIG. 11A is a diagram illustrating an operation, by the user, to move the first answer [1] of a supporter A model to the first answer [3] of a supporter C model in the state illustrated in FIG. 8;

FIG. 11B is a diagram illustrating an example of the first answer [3 (new)] output from the supporter A model after the operation by the user illustrated in FIG. 11A;

FIG. 12 is a diagram illustrating input/output related to a machine learning model in the flip function related to the machine learning model in the dialog ability enhancement assistance device 10 according to the present disclosure;

FIG. 13 is a flowchart illustrating the operation of the dialog ability enhancement assistance device 10 according to the present disclosure;

FIG. 14 is a block diagram illustrating a configuration of a dialog ability enhancement assistance device 30 according to the present disclosure;

FIG. 15 is a flowchart illustrating the operation of the dialog ability enhancement assistance device 30 according to the present disclosure; and

FIG. 16 is a block diagram illustrating a configuration of an information processing device 900 capable of achieving the dialog ability enhancement assistance device according to the present disclosure.

### EXAMPLE EMBODIMENT

Next, a detailed explanation will be given for a first example embodiment with reference to the drawings.

### First Example Embodiment

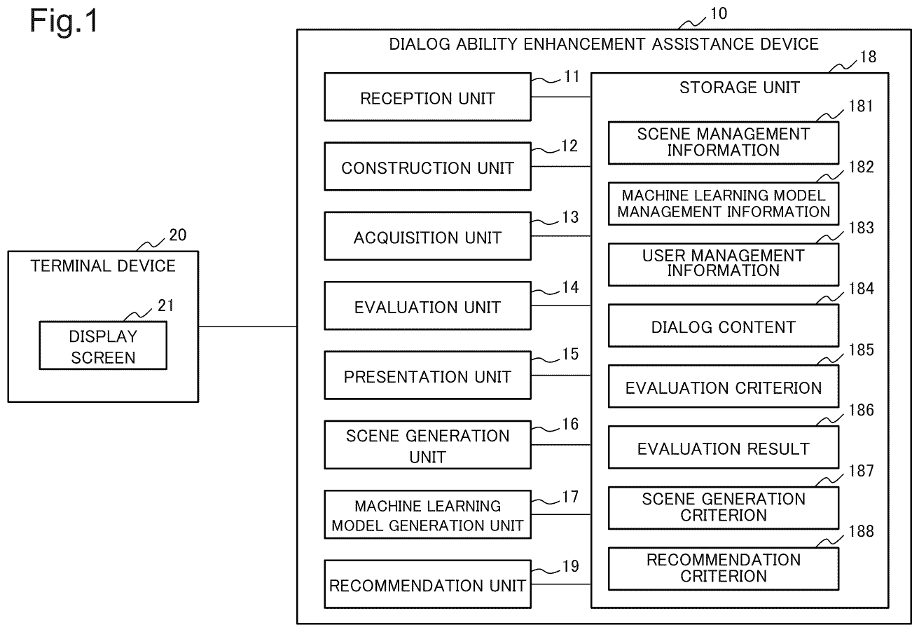

FIG. 1 is a block diagram illustrating a configuration of a dialog ability enhancement assistance device 10 according to the present disclosure. The dialog ability enhancement assistance device 10 is a device that provides an environment in which a dialog (communication) is performed in various scenes in which participants including the user and one or more machine learning models (artificial intelligence) is assumed, and assists the user in enhancing the dialog ability through the dialog. The machine learning model is, for example, generative AI having a function of naturally having a dialog with a user by a large-scale language model. The number of users included in participants may be plural.

### (Definition of Machine Learning Model)

A machine learning model and generation of the machine learning model will be outlined.

The machine learning model is a model that generates an answer to a request. As an example, when a query generated based on a request or the like from the user is input, the machine learning model outputs an answer to the query.

As an example, the machine learning model is configured by a language model. For example, the language model may be referred to as a large language model (LLM), but is not limited thereto.

The language model is a machine learning model (also referred to as a generative model) that inputs a language to output a language. The language model is a model that learns a relationship between words in a sentence and generates a related character string related to a target character string from the target character string. By using a language model that was trained on texts and sentences in various contexts, it is possible to generate a related character string having appropriate content related to the target character string.

For example, a case where a language model is used in the question and answer will be described. The language model receives an input of a question, saying “What country is Japan?” as the target character string. The language model generates a character string such as “Japan is an island country in the Northern Hemisphere” as an answer to the question.

A method of training the language model is not particularly limited, but as an example, the language model may be trained in such a way as to output at least one sentence including an input character string. As a specific example, the language model is a generative pretrained-transformer (GPT) that outputs a sentence including an input character string by predicting a character string having a high probability following the input character string.

In addition to this, for example, text-to-text transfer transformer (T5), bidirectional encoder representations from transformers (BERT), robustly optimized BERT approach (RoBERTa), efficiently learning an encoder that classifies token replacements accurately (ELECTRA), and the like are also language models.

Alternatively, the language model may output a natural language related to a character string input in an artificial language. The content generated by the language model is not limited to a character string. The language model may generate, for example, image data, video data, audio data, or other data formats related to an input character string.

The dialog ability enhancement assistance device 10 is communicably connected to a terminal device 20. The terminal device 20 is an information processing device such as a personal computer, a smartphone, or a tablet terminal. The terminal device 20 inputs information input via an input operation by the user to the dialog ability enhancement assistance device 10, and displays the information output from the dialog ability enhancement assistance device 10 on a display screen 21 provided.

The dialog ability enhancement assistance device 10 is an information processing device such as a server, for example, and includes a reception unit 11, a construction unit 12, an acquisition unit 13, an evaluation unit 14, a presentation unit 15, a scene generation unit 16, a machine learning model generation unit 17, a storage unit 18, and a recommendation unit 19. The reception unit 11, the construction unit 12, the acquisition unit 13, the evaluation unit 14, the presentation unit 15, the scene generation unit 16, the machine learning model generation unit 17, and the recommendation unit 19 are examples of a reception means, a construction means, an acquisition means, an evaluation means, a presentation means, a scene generation means, a machine learning model generation means, and a recommendation means, respectively.

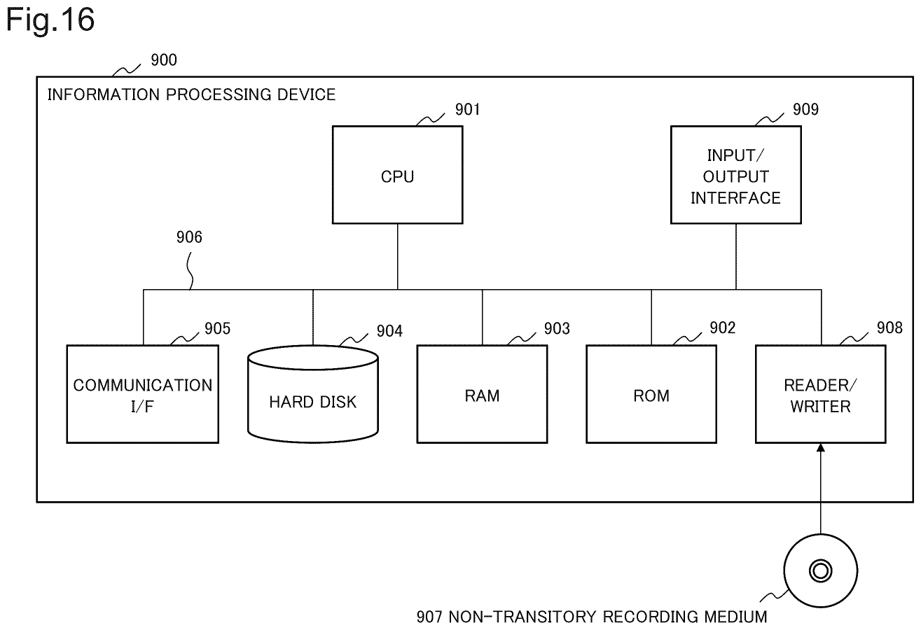

The storage unit 18 is, for example, a storage device such as a random access memory (RAM) 903 or a hard disk 904 described later with reference to FIG. 16. The storage unit 18 stores scene management information 181, machine learning model management information 182, user management information 183, dialog content 184, an evaluation criterion 185, an evaluation result 186, a scene generation criterion 187, and a recommendation criterion 188. Details of these pieces of the above information stored in the storage unit 18 will be described later.

The reception unit 11 receives, from the terminal device 20, information for select a scene in which participants including the user and one or more machine learning models have a dialog, and the machine learning models included in the participants, the information being input by the user.

For example, the reception unit 11 displays the scene management information 181 stored in the storage unit 18 on the display screen 21 of the terminal device 20 as an option when the user selects a scene to have a dialog. The scene management information 181 is given in advance by, for example, an administrator or the like of the dialog ability enhancement assistance device 10.

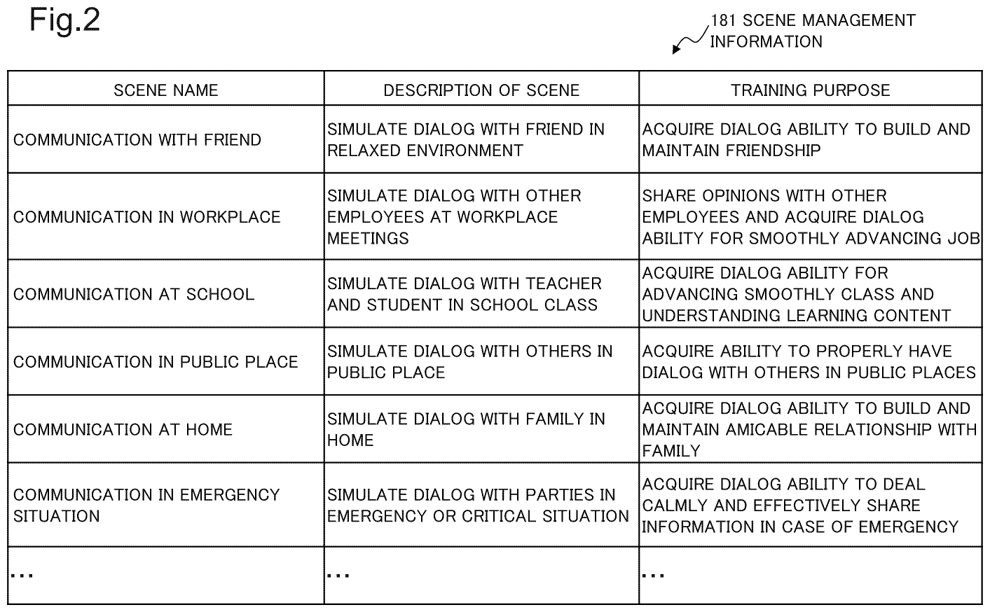

FIG. 2 is a diagram illustrating the content of the scene management information 181 in the dialog ability enhancement assistance device 10 according to the present disclosure. The scene management information 181 illustrated in FIG. 2 indicates a scene name, description of the scene, and a purpose of training a dialog with respect to a scene of an individual dialog. The scene management information 181 illustrated in FIG. 2 is an example, and the scene management information 181 may include content different from the content illustrated in FIG. 2.

The scene management information 181 illustrated in FIG. 2 includes, as dialog scenes, communication with a friend, communication in a workplace, communication at school, communication in a public place, communication at home, communication in an emergency, and the like. According to the scene management information 181, for the learning purpose, for example, communication with friends is to simulate a dialog with a friend in a relaxed environment and acquire a dialog ability (dialog skill) for building and maintaining a friendship. According to the scene management information 181, for the learning purpose, for example, communication in the workplace is to simulate a dialog with other employees in a workplace meeting, share an opinion with other employees, and acquire a dialog ability for smoothly advancing a job. The user selects a scene in which the user desires to enhance the dialog ability from among the scenes indicated by the scene management information 181 displayed on the display screen 21.

For example, the reception unit 11 displays the machine learning model management information 182 on the display screen 21 of the terminal device 20 as an option when the user selects the machine learning model included in the participants of the dialog. The machine learning model management information 182 is given in advance by, for example, an administrator or the like of the dialog ability enhancement assistance device 10.

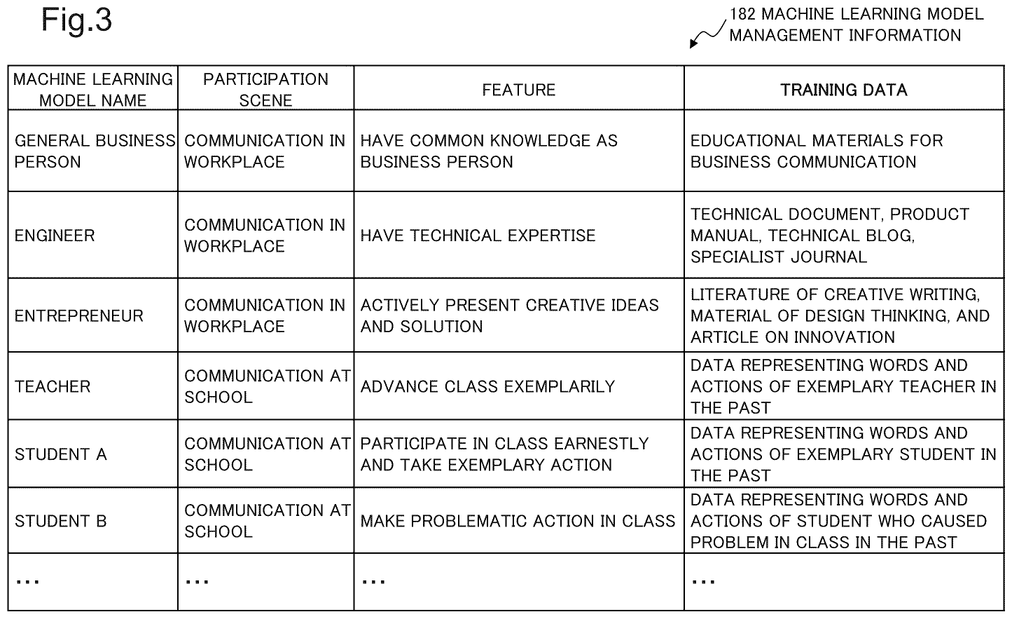

FIG. 3 is a diagram illustrating the content of the machine learning model management information 182 in the dialog ability enhancement assistance device 10 according to the present disclosure. The machine learning model management information 182 illustrated in FIG. 3 indicates a dialog participation scene, a feature of the dialog participation scene, and training data used when the machine learning model is generated with respect to individual machine learning models having different features. The machine learning model management information 182 illustrated in FIG. 3 is an example, and the machine learning model management information 182 may include content different from the content illustrated in FIG. 3.

The machine learning model management information 182 illustrated in FIG. 3 includes, as a machine learning model, a general business person, an engineer, an entrepreneur, a teacher, a student A, a student B, and the like. According to the machine learning model management information 182, for example, a general business person is a machine learning model having common knowledge as a business person as a feature thereof, and generated by learning educational materials and the like related to business communication. According to the machine learning model management information 182, for example, the engineer is a machine learning model having technical expertise as a feature thereof, and generated by learning a technical document, a product manual, a technical blog, a specialist journal, or the like. The user selects a machine learning model that the user wants to participate in the dialog from among the scenes indicated by the scene management information 181 displayed on the display screen 21 in order to improve the user's own dialog ability.

Each machine learning model (language model) is generated based on the training data. For example, in a case of generating a machine learning model reflecting an idea of an expert, training (learning) of the machine learning model is performed by utilizing various training data (data resources) such as public remarks in a media or the like of the expert, related industry sentences, and reports.

Alternatively, a machine learning model having a specific personality may be generated by utilizing an existing machine learning model (language model). For example, transfer learning (fine tuning) for training the weights of a pre-trained model with new training data may be performed. Specifically, the machine learning model may have a feature by using an existing language model and performing additional training with unique training data (data set). The machine learning model may be characterized (personalized) by preparing each of the teacher's remark and the student's remark as training data and additionally training the basic machine learning model with these pieces of training data.

A “feedback” method may be used to generate the machine learning model. For example, an evaluator (a generator of the machine learning model) or the like determines appropriateness/inappropriateness of the feedback with respect to the output from the machine learning model. The determination result is used as training data to execute relearning. As a result, the performance (output accuracy) of the machine learning model is improved. For example, in a case of generating a machine learning model (teacher model) reflecting the idea of the teacher, the evaluator (generator of the machine learning model) may perform feedback in such a way that the output result of the teacher model “is closer to a specific teacher”.

Regarding the characterization (personalization) of the machine learning model, the machine learning model may be characterized by so-called “prompt engineering” in addition to the generation of the machine learning model by the training data. That is, the output of the machine learning model may be guided (defined) by a designated method by devising a question or an instruction (prompt) input to the machine learning model. For example, when it is desired to obtain an answer like a teacher (when it is desired to utilize an existing machine learning model as a teacher model), a fixed phrase such as “Please think like a teacher” may be input to the machine learning model. Alternatively, remarks or the like related to the teacher may be acquired from the database, and the remarks obtained from the database may be input to the machine learning model together with the fixed phrases.

The construction unit 12 illustrated in FIG. 1 constructs an environment in which participants including the machine learning model selected by the user as described above have a dialog in a dialog scene selected by the user as described above. Specifically, the construction unit 12 constructs the environment as a program and data to be processed by the dialog ability enhancement assistance device 10, and constructs a function of a user interface for a dialog between the user and the machine learning model. For example, the construction unit 12 constructs a function of displaying the remark by the machine learning model included in the participants on the display screen 21, and inputting the textual information input through the input operation by the user to the terminal device 20 or the remark content of the user represented as a result of voice recognition of the voice uttered by the user to the machine learning model included in the participants.

For example, the construction unit 12 constructs an environment in which participants have a dialog with each other on a topic included in a scenario according to the scenario in which the participants have a dialog with each other, the scenario being given in advance by the administrator or the like of the dialog ability enhancement assistance device 10 for each dialog scene. The scenario includes, for example, remark content at the time of starting a dialog by a certain machine learning model included in the participants, a role of each machine learning model included in the participants, and the like. The construction unit 12 may store information indicating the constructed environment in the storage unit 18.

The acquisition unit 13 acquires the dialog content 184 with the machine learning model by the user in the environment constructed as described above by the construction unit 12.

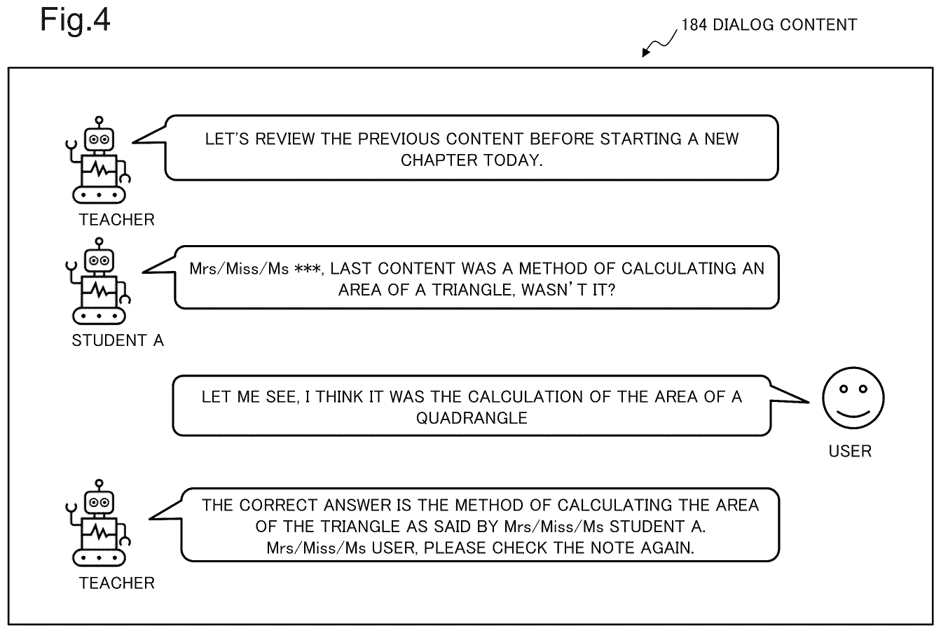

FIG. 4 is a diagram illustrating a first example of the dialog content 184 in the dialog ability enhancement assistance device 10 according to the present disclosure. FIG. 4 illustrates an example of an aspect in which the dialog content 184 is displayed on the display screen 21. In the example illustrated in FIG. 4, it is assumed that communication at school is selected by the user from among scenes indicated by the scene management information 181 illustrated in FIG. 2 as a dialog scene, and a teacher and a student A are selected from among machine learning models indicated by the machine learning model management information 182 illustrated in FIG. 3 as a machine learning model to participate in the dialog. Participation of the teacher and the student A in the dialog may be designated in advance in a scenario regarding a communication scene at school.

According to the dialog content 184 illustrated in FIG. 4, first, the dialog is started from the teacher's remark that “Let's review the previous content before starting a new chapter today”. Next, in response to the teacher's remark described above, the student A says “Mrs/Miss/Ms ***, last content was a method of calculating an area of a triangle, wasn't it?”. Next, in response to the remark by the student A, the user says “Let me see, I think it was the calculation of the area of a quadrangle”. Then, in response to the user's remark, the teacher says “The correct answer is the method of calculating the area of the triangle as said by Mrs/Miss/Ms student A. Mrs/Miss/Ms User, please check the note again”.

The evaluation unit 14 illustrated in FIG. 1 evaluates the dialog ability of the user from the dialog content 184 acquired by the acquisition unit 13 based on an evaluation criterion 185 for evaluating the dialog ability of the user according to the dialog content 184. The evaluation unit 14 analyzes the meaning of the user's remark using, for example, an existing semantic analysis technology, and in this case, the evaluation criterion 185 includes a criterion for evaluating how appropriate the user's remark is with respect to the scenario of the dialog scene. The evaluation unit 14 analyzes the emotion of the user indicated by the user's remark using, for example, an existing emotion analysis technology, and in this case, the evaluation criterion 185 includes a criterion for evaluating whether the emotion of the user is positive or negative. The evaluation criterion 185 are given in advance by, for example, an administrator or the like of the dialog ability enhancement assistance device 10.

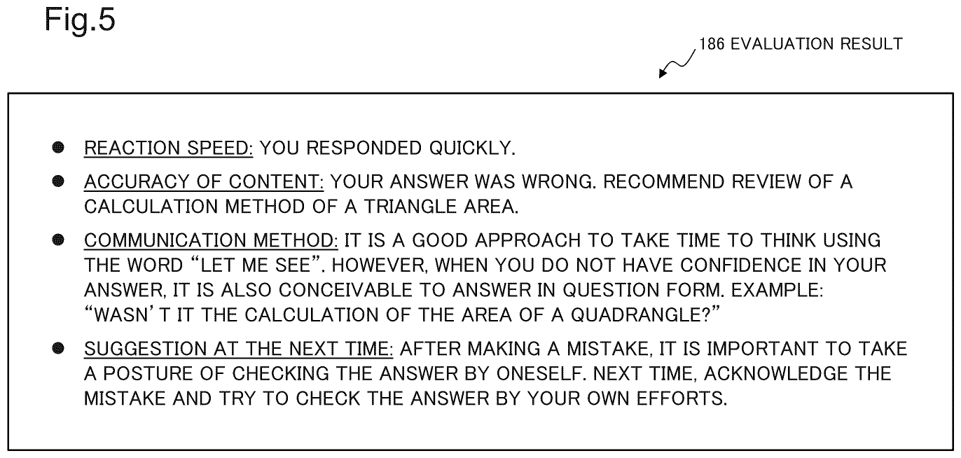

FIG. 5 is a diagram illustrating the evaluation result 186 of the dialog ability of the user by the evaluation unit 14 with respect to the dialog content 184 illustrated in FIG. 4 in the dialog ability enhancement assistance device 10 according to the present disclosure. FIG. 5 illustrates an example of an aspect in which the evaluation result 186 is displayed on the display screen 21.

According to the evaluation result 186 illustrated in FIG. 4, the evaluation unit 14 evaluates the user's reaction speed as “You responded quickly”. This evaluation is performed because the time interval between the remark by the student A and the remark by the user is shorter than the threshold value indicated by the evaluation criterion 185. According to the evaluation result 186 illustrated in FIG. 4, regarding the accuracy of the content of the user's remark, the evaluation unit 14 performs the evaluation and suggestion, saying that “Your answer was wrong. We recommend you to review triangle area calculation method”. The evaluation and the suggestion are based on an evaluation criterion 185 indicating that, when there is a mistake in the user's remark, the mistake is pointed out and the mistake is corrected. Regarding the method of communication, the evaluation unit 14 performs the evaluation and suggestion, saying that “it is a good approach that you have taken time to think using the words “Let me see”. However, when you do not have confidence in your answer, it is also conceivable to answer in question form. Example: “Wasn't it the calculation of the area of a quadrangle?””. Furthermore, as the next proposal, the evaluation unit 14 performs the evaluation and suggestion, saying that “It is important to take a posture of checking an answer by oneself after making a mistake. Next time, acknowledge the mistake and try to check the answer by your own efforts”. These evaluations and suggestions by the evaluation unit 14 are based on an evaluation criterion 185 that associates content of remarks by the user with content of evaluations and suggestions for the user who has made the remarks.

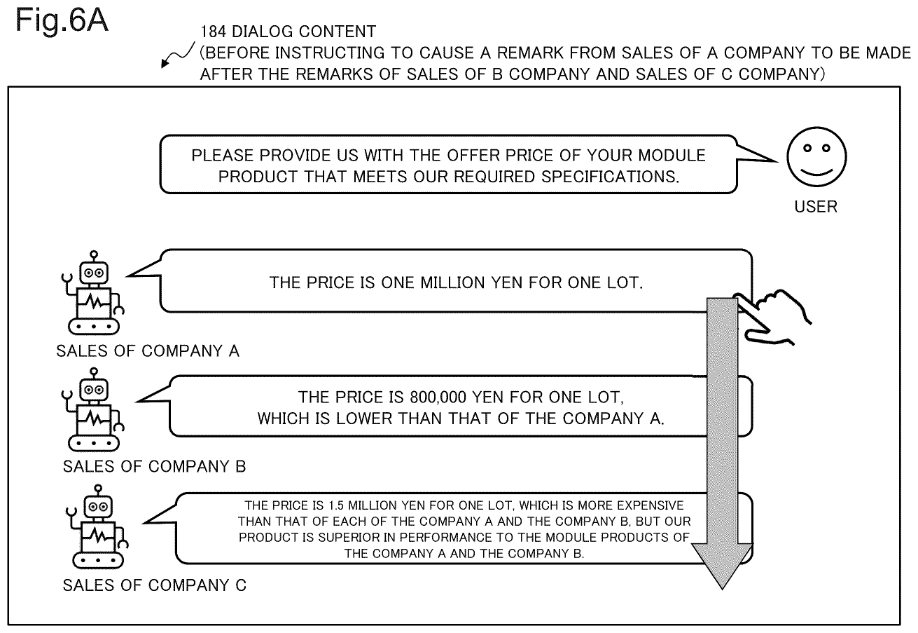

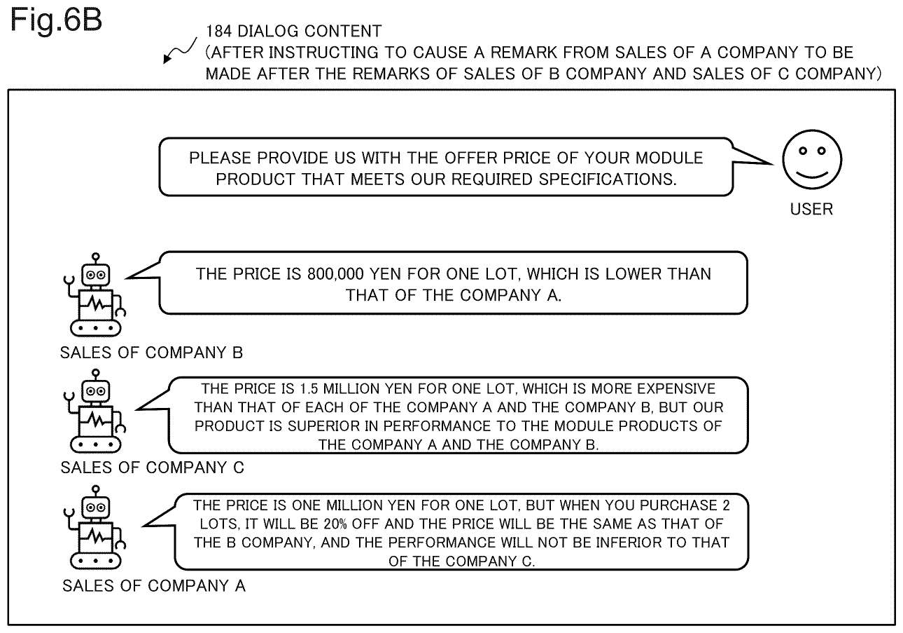

FIGS. 6A and 6B are diagrams illustrating a second example of the dialog content 184 in the dialog ability enhancement assistance device 10 according to the present disclosure. FIGS. 6A and 6B illustrate an example of an aspect in which the dialog content 184 is displayed on the display screen 21, as in FIG. 4. In the examples illustrated in FIGS. 6A and 6B, it is assumed that communication in a business negotiation with another company (not illustrated in FIG. 2) is selected by the user as a dialog scene among dialog scenes indicated by the scene management information 181, and sales of the company A, sales of the company B, and sales of the company C (not illustrated in FIG. 3) are selected as machine learning models to participate in the dialog.

According to the dialog content 184 illustrated in FIG. 6A, in response to the user's remark that “Please provide us with the offer price of your module product that meets our required specifications” in the business negotiation, the sales of the company A, the sales of the company B, and the sales of the company C each make a remark regarding the price at which the company's products are provided and, if necessary, the superiority of the company's products over the other company's products.

In the example illustrated in FIGS. 6A and 6B, the display screen 21 of the terminal device 20 has a touch panel function. Then, in a case where an input operation is performed on the display screen 21 by a user who drags and moves a display area representing a remark made by a certain machine learning model to the bottom of the screen, the construction unit 12 constructs a dialog environment in which the machine learning model makes a remark according to a remark made by other machine learning models.

In the example illustrated in FIGS. 6A and 6B, in order to check how the sales of the company A appeal the superiority of the own product in response to the remarks by the sales of the company B and the sales of the company C, the user who has shown an interest in the company A drags and moves the display area representing the remarks of the sales of the company A to the bottom of the screen as illustrated in FIG. 6A. As a result, as illustrated in FIG. 6B, the sales of the company A makes a remark to appeal the superiority of the own company's product over other company's products, saying that “The price is one million yen for one lot, but when you purchase 2 lots, it will be 20% off and the price will be the same as that of the B company, and the performance will not be inferior to that of the company C” based on the remarks by the sales of the company B and the sales of the company C.

The environment of the dialog as illustrated in FIGS. 6A and 6B is constructed by the construction unit 12, whereby the user can practice the dialog for enhancing the dialog ability in the business negotiation in such a way that the user can determine the supplier from which the user can purchase the product under the optimum condition in the business negotiation with a plurality of companies for determining the supplier of a certain product.

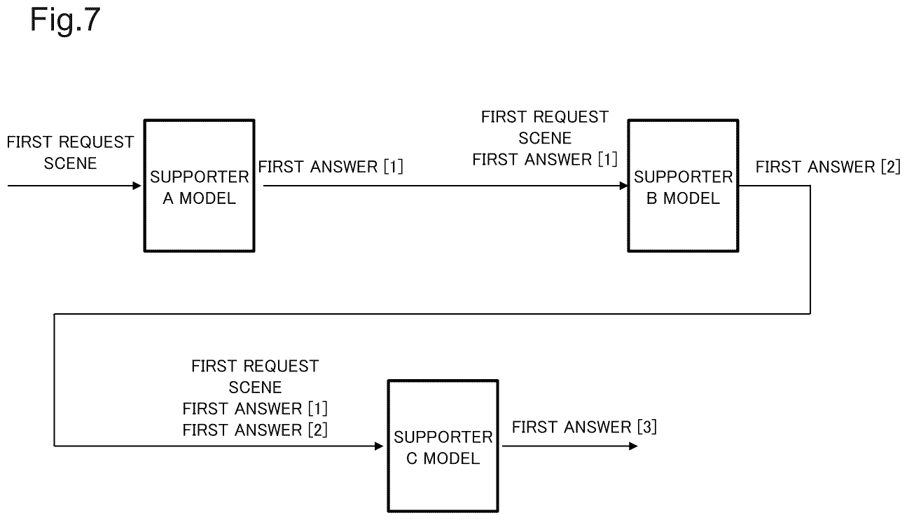

A method in which the machine learning model generates a dialog in the construction unit 12 will be described with reference to FIGS. 7 to 12. FIGS. 7 to 12 are diagrams for describing a method in which the machine learning model generates a dialog in the dialog ability enhancement assistance device 10, taking a dialog scene in the child support service as an example. The construction unit 12 includes a dialog generation unit 120 (not illustrated in FIG. 1).

The dialog generation unit 120 has a basic function, an intervention function, a flip function, and the like. The dialog generation unit 120 implements these functions using a plurality of machine learning models selected by the user.

### (Basic Function)

First, the basic function will be described.

The basic function is a function of sequentially presenting answers from a plurality of machine learning models to a user's question (answer request). In the basic function, the second and subsequent machine learning models answers while referring to the answers from the machine learning models that have been answered so far.

The request (question from the user) and the answer (response by the machine learning model) in the basic function are described as a first request and a first answer. For one first request, a first answer is obtained from each of the plurality of machine learning models. The plurality of first answers may be different from each other.

The first answer to the first request (an answer of the first machine learning model) is described as a first answer [1]. Similarly, the second answer to the first request is described as a first answer [2], and the third answer is described as a first answer [3]. The first answer from the k-th machine learning model is expressed as a first answer [k] (k is a positive integer, and the same applies hereinafter).

Further, a plurality of first answers is collectively referred to as a first answer set.

The dialog generation unit 120 acquires the first request from the user. The dialog generation unit 120 inputs the acquired first request to one machine learning model of a plurality of machine learning models selected by the user.

Specifically, the dialog generation unit 120 selects one machine learning model from among a plurality of machine learning models selected by the user. Furthermore, the dialog generation unit 120 generates a query based on the first request and the scene selected by the user in such a way as to obtain an answer related to the scene selected by the user. The dialog generation unit 120 inputs the generated query to the selected one machine learning model.

For example, when the user selects three models of the supporter A model, the supporter B model, and the supporter C model illustrated in FIG. 7, the dialog generation unit 120 selects the supporter A model from among the three machine learning models. The dialog generation unit 120 inputs a query to the selected teacher model.

When the dialog generation unit 120 acquires the output data (first answer [1]) from the machine learning model, the dialog generation unit 120 selects one machine learning model from among a plurality of machine learning models selected by the user and to which no query is input. For example, in the above example, the supporter B model is selected from the supporter B model and the supporter C model.

The dialog generation unit 120 generates a query to be input to the second selected machine learning model based on the first request, the scene selected by the user, and the output data (first answer) of the machine learning model that has answered. In the above example, the dialog generation unit 120 generates a query (query for the supporter B model) to be input to the supporter B model according to the first request, the scene, and the first answer [1] of the supporter A model.

The dialog generation unit 120 inputs the generated query to the second selected machine learning model to obtain output data (first answer [2]). In the above example, the dialog generation unit 120 obtains the first answer [2] from the supporter B model.

When the dialog generation unit 120 obtains the first answer [2] from the second machine learning model, the dialog generation unit 120 selects the third machine learning model from which the answer is to be obtained. In the above example, the supporter C model is selected.

When the dialog generation unit 120 selects the third machine learning model, the dialog generation unit 120 generates a query for the third machine learning model based on the first request, the scene, and the output data (first answer [1], first answer [2]) of the machine learning model that has answered, as in the case of the second machine learning model. The dialog generation unit 120 obtains the first answer [3] from the third machine learning model using the generated query. In the above example, the dialog generation unit 120 obtains the first answer [3] from the supporter C model.

The input/output related to the three machine learning models is summarized as illustrated in FIG. 7. As illustrated in FIG. 7, the dialog generation unit 120 adds an answer (output data) of the machine learning model that has answered to a user's question (answer request) and the scene, and inputs them to the machine learning model in the subsequent stage, thereby obtaining an answer of the machine learning model with reference to the answer of the previous machine learning model.

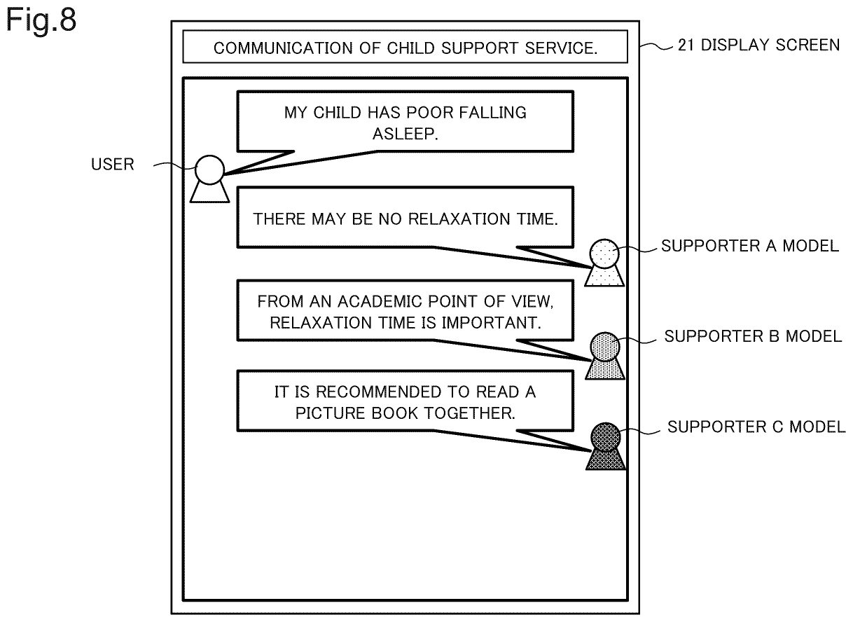

When obtaining the first answer [1] to the first answer [3] from each machine learning model selected by the user in response to the first request of the user, the dialog generation unit 120 displays the first answer (first answer set) of each machine learning model on the display screen 21 of the terminal device 20 (see FIG. 8).

FIG. 8 illustrates an example of the first request and the first answer in a case where the user selects “communication of the child support service” as the dialog scene as described above, and selects three models of the supporter A model, the supporter B model, and the supporter C model as the machine learning models.

On the display screen 21 exemplified in FIG. 8, a person (icon) on the left side indicates a user (questioner). A person (icon) on the right side indicates a machine learning model (answerer). Furthermore, the dialog generation unit 120 enables the user to easily identify the answerer by changing the color or the like of the icon related to each machine learning model. For example, in FIG. 8, the right icon corresponds to each of the supporter A model, the supporter B model, and the supporter C model in order from the top.

The user who thinks that the problem or the like has been solved by the first answer (first answer set) from each machine learning model terminates the child support service.

The “intervention function” and the “flip function” are functions that meet the request of the user who desires more answers and deeper content answers.

### (Intervention Function)

The intervention function is a function of sequentially acquiring new answers from a plurality of machine learning models by the user adding (intervening) a question to the first answer (first answer set) obtained by the basic function. The intervention function is a function of answering an additional question by the user.

In the intervention function, a new answer referring to a new answer of each machine learning model acquired so far is obtained from the second and subsequent machine learning models.

The request and the new answer added in the intervention function are referred to as a second request and a second answer. For one second request, the second answer is obtained from each of the plurality of machine learning models. A plurality of second answers is collectively referred to as a second answer set.

The intervention function may be further executed for the second and subsequent answers. The new request and the new answer in the intervention function performed on the n-th answer (n is a positive integer) are described as an (n+1)-th request and an (n+1)-th answer, and the plurality of (n+1)-th answers is collectively described as an (n+1)-th answer set.

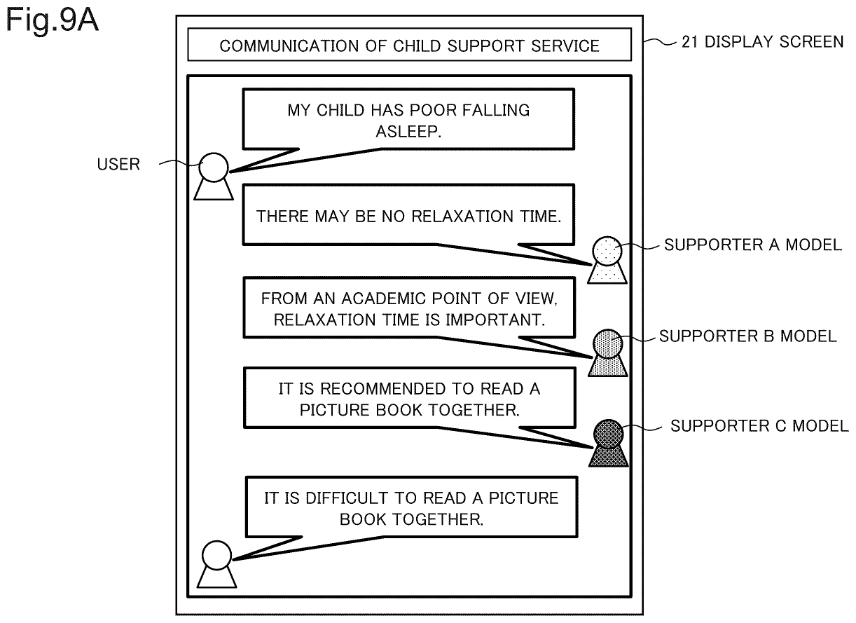

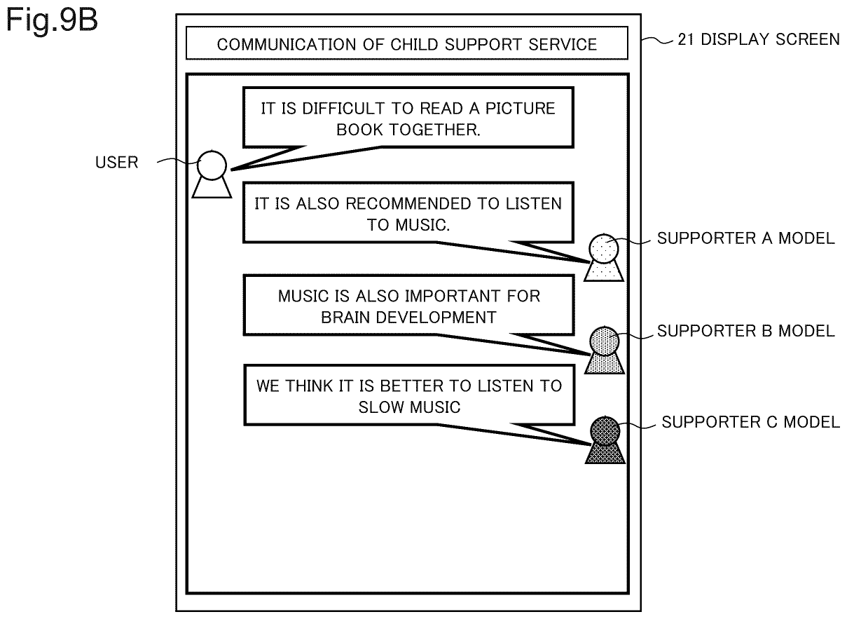

For example, in the state illustrated in FIG. 8 (state in which the first answer set is displayed), the user inputs an additional question (second request) to the dialog generation unit 120 (see FIG. 9A).

When acquiring the additional question (second request) from the user, the dialog generation unit 120 generates a query from the second request of the user, the scene selected by the user, and the first request and/or the first answer set. The dialog generation unit 120 inputs the generated query to one of the plurality of machine learning models selected by the user.

For example, the dialog generation unit 120 inputs the generated query to the machine learning model (in the above example, the supporter A model) selected first in the basic function. The dialog generation unit 120 obtains the second answer [1] from the machine learning model.

As in the basic function, the dialog generation unit 120 generates a query for inputting to the second selected machine learning model. The dialog generation unit 120 generates a query based on the second request, the scene, the first request and/or the first answer set, and the second answer [1] of the machine learning model selected first. The dialog generation unit 120 inputs the generated query to the second machine learning model (the supporter B model in the above example).

The dialog generation unit 120 performs the similar processes for the third machine learning model (supporter C model).

When obtaining a second answer (second answer set) from each machine learning model selected by the user in response to the second request of the user, the dialog generation unit 120 displays the second answer on the display screen 21 of the terminal device 20 (see FIG. 9B).

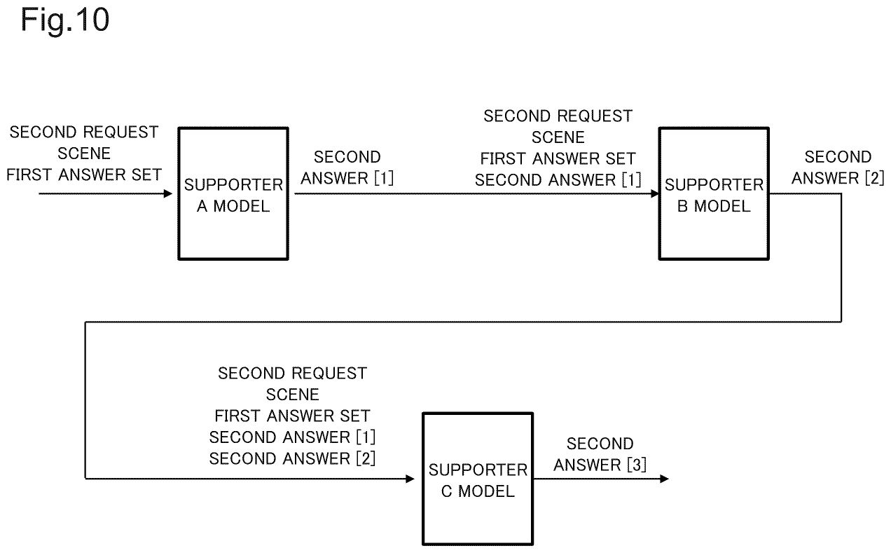

The input/output related to the three machine learning models in the intervention function is summarized as illustrated in FIG. 10. In FIG. 10, the first answer set obtained by the basic function is used for generating each query.

In this manner, the user can repeatedly ask a question to the dialog generation unit 120 (the machine learning model selected by the user) using the intervention function.

### (Flip Function)

The flip function is a function in which the user changes (flips) the order of using a plurality of machine learning models with respect to the answer obtained by the basic function.

In the flip function, for at least one machine learning model, a new first answer referring to the already obtained first answer is obtained from each machine learning model having an earlier order after the change from the machine learning model.

The order of the machine learning model after being changed by the flip function is denoted as k (new). For example, the dialog generation unit 120 causes one machine learning model [k (new)] to refer to the first answers [1] to [k (new)−1] obtained from the machine learning models [1] to [k (new)−1] whose order after the change is earlier than that of the machine learning model [k (new)]. As a result, the dialog generation unit 120 acquires a new first answer [k (new)] related to the first request from the machine learning model [k (new)]. The dialog generation unit 120 may acquire a new n-th answer based on the order change instruction for the n-th answer set.

For example, the user who has confirmed the answer of each machine learning model illustrated in FIG. 8 wants to know deeper content of the answer of the supporter A model. Specifically, the user wants to know the answer of the supporter A model based on the answer of other machine learning models (supporter B model, supporter C model) to his/her question.

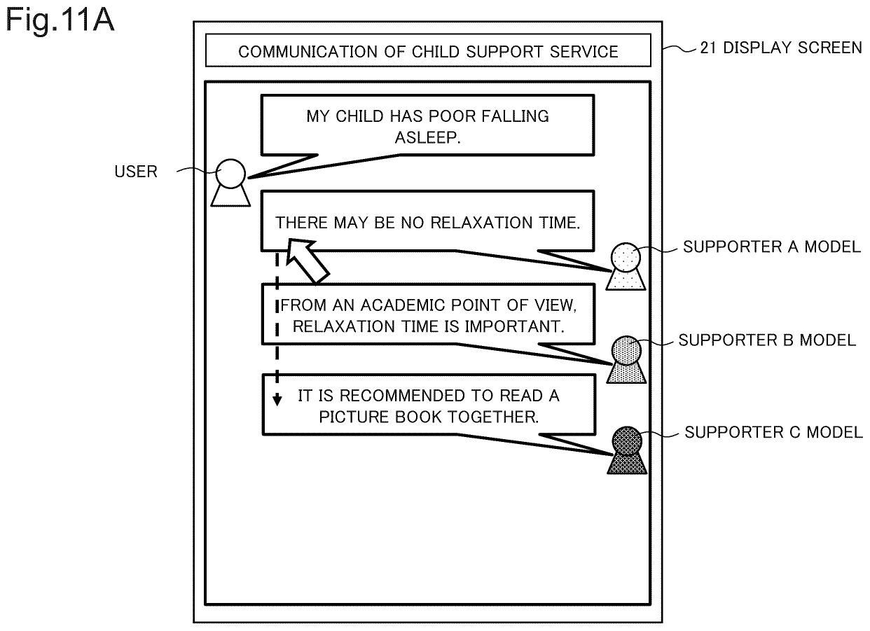

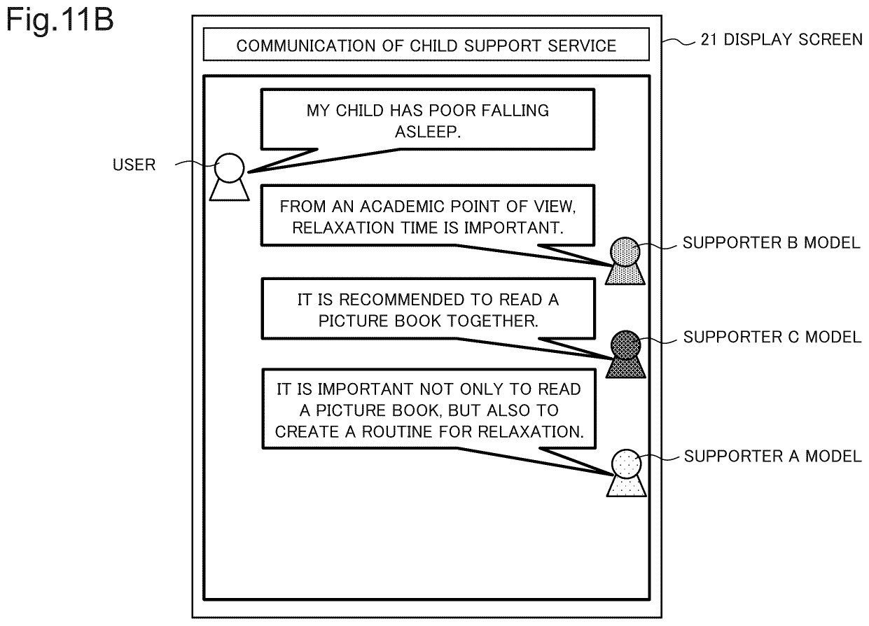

In this case, the user gives an “order change instruction” to the dialog generation unit 120 in such a way that the supporter A model replies last. Although the specific operation content of the order change instruction will be described later, as illustrated in FIG. 11A, the user performs an operation to move the first answer [1] of the supporter A model to the first answer [3] of the last supporter C model.

Upon receiving the order change instruction, the dialog generation unit 120 generates a query to be input to the machine learning model whose order has been changed by the user. Specifically, the dialog generation unit 120 generates a query based on the first request, the scene, and the first answer [2] and the first answer [3] of the machine learning model that has already answered.

The dialog generation unit 120 inputs the generated query to the machine learning model whose order has been changed by the user. As described above, when the teacher model is changed in such a way as to answer last, the dialog generation unit 120 acquires the first answer [3 (new)] from the supporter A model. The dialog generation unit 120 displays the acquired first answer [3 (new)] on the display screen 21 of the terminal device 20 (see FIG. 11B).

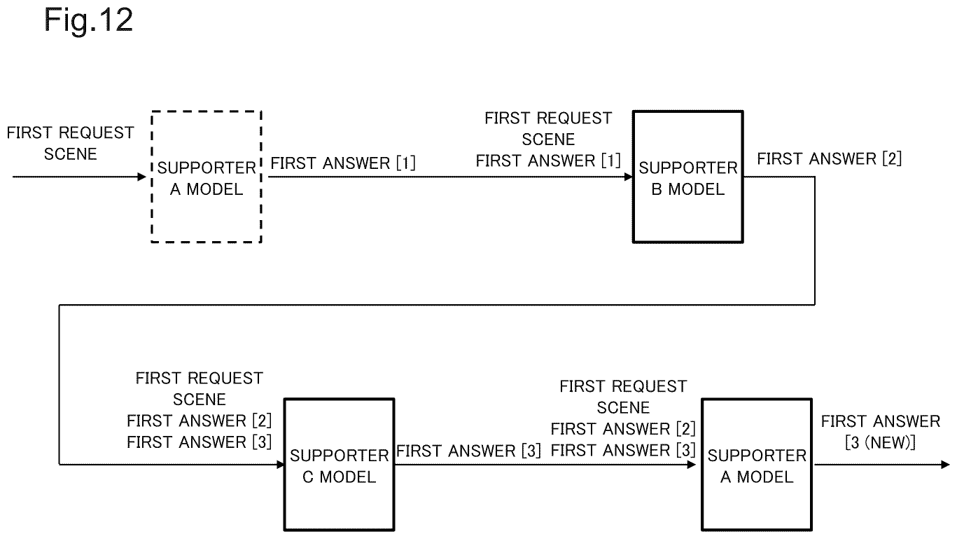

The input/output related to the three machine learning models in the flip function is summarized as illustrated in FIG. 12. As illustrated in FIG. 12, the order of the supporter A model selected by the dialog generation unit 120 as the machine learning model to be answered first in the basic function is changed by the user as the machine learning model to be answered last. That is, the answer order of the supporter A model, the supporter B model, and the supporter C model is changed to the answer order of the supporter B model, the supporter C model, and the supporter A model by the user utilizing the flip function.

The presentation unit 15 illustrated in FIG. 1 presents the evaluation result 186 exemplified in FIG. 5 by the evaluation unit 14 to the user by displaying the evaluation result on the display screen 21 of the terminal device 20, for example.

The scene generation unit 16 generates a scene of the dialog from the user management information 183 based on the scene generation criterion 187 for generating a scene of the dialog according to the feature of the user indicated by the user management information 183. The scene generation unit 16 may be a machine learning model including a large-scale language model. The scene generation unit 16 may store information indicating the generated scene in the storage unit 18.

The user management information 183 represents, for example, a feature of the user based on at least one of attributes including an age, a gender, an occupation, a preference, a personality, and the like, a feature indicated by the record of the dialog content 184 so far using the dialog ability enhancement assistance device 10, and a feature indicated by the record of the evaluation result 186, regarding the user. For example, the user management information 183 may be generated or updated by the user himself/herself, or may be generated or updated by the acquisition unit 13 or the evaluation unit 14. For example, the acquisition unit 13 may acquire the feature of the user including the preference of the user by analyzing the acquired dialog content 184, and reflect the acquired feature of the user in the user management information 183. For example, as illustrated in FIG. 6A, the acquisition unit 13 may estimate the tendency of the keyword included in the display area from the history of the display area representing the remark by the machine learning model that the user has dragged and moved to the bottom of the screen so far, and acquire the feature of the user including the preference of the user from the estimation result.

An example of scene generation by the scene generation unit 16 will be described. For example, it is assumed that a machine learning model X and a machine learning model Y, which are participants, conflict with each other in a dialog that a certain user had using the dialog ability enhancement assistance device 10 in the past, and the user is in a position to mediate between the machine learning model X and the machine learning model Y in the scene, but the arbitration fails due to supporting either the machine learning model X or the machine learning model Y. In this case, the evaluation unit 14 generates the evaluation result 186 indicating that the user lacks the dialog ability to mediate between the opposing persons, and reflects the feature that the user lacks the dialog ability to mediate between the opposing persons in the user management information 183. Specifically, for example, the evaluation unit 14 identifies, from the keywords included in the outputs from the machine learning models X and Y, that the machine learning model X claims the importance of the price and the machine learning model Y claims the importance of the performance in a dialog scene in which future business directionality is discussed. The evaluation unit 14 identifies that the user claims the importance of the price without considering the importance of the performance (that is, supports the machine learning model X) from the keywords included in the remark of the user. The evaluation unit 14 further identifies that the machine learning model Y is greatly dissatisfied from the keyword included in the output from the machine learning model Y in response to the user's remark. As a result, the evaluation unit 14 determines that arbitration between the machine learning models X and Y by the user has failed. Then, the scene generation unit 16 newly generates a scene of a dialog in which a plurality of machine learning models in different positions intensely oppose each other in such a way that the user can learn a dialog ability for appropriately mediating between opposing people. In this case, the scene generation criterion 187 indicates that, in a case where the user lacks the dialog ability for mediating between the opposing persons, a scene of a dialog in which a plurality of machine learning models in different positions intensely oppose each other is generated.

The machine learning model generation unit 17 trains (generates or updates) the machine learning model by, for example, learning words and actions of a real or fictitious character. For example, the machine learning model generation unit 17 trains a machine learning model that reproduces a concept including values and the like of a modern famous person or a historical great person by learning information indicating words and actions of the modern famous person or the historical great person. Alternatively, the machine learning model generation unit 17 learns words and actions of a fictitious character appearing in a work such as a novel to train a machine learning model that reproduces a concept including the values of the fictitious character. At this time, the machine learning model generation unit 17 may train the machine learning model by repeating predicting words and actions of a person to be a model of the machine learning model to be generated. The machine learning model generation unit 17 registers the newly generated machine learning model in the machine learning model management information 182. The machine learning model generation unit 17 may store information representing the generated machine learning model in the storage unit 18.

The machine learning model generation unit 17 includes, as a function of the machine learning model to be generated, a function of determining whether the relevance (the direction of the dialog) between the dialog content 184 and the dialog scene satisfies a predetermined criterion, and guiding the dialog with the user in such a way that the dialog content 184 satisfies the predetermined criterion in a case where the relevance does not satisfy the predetermined criterion. The predetermined criterion is given in advance by, for example, an administrator or the like of the dialog ability enhancement assistance device 10.

For example, it is assumed that, in the scene of the business negotiation illustrated in FIGS. 6A and 6B, the user refers to a topic (for example, a topic related to a famous person, an event, or the like having low relevance to the business negotiation) whose relevance to the business negotiation falls below a predetermined criterion. In this case, the machine learning model generated by the machine learning model generation unit 17 makes a remark to return the dialog topic to the business negotiation without touching the topic mentioned by the user, for example. For example, the machine learning model may have a function of calculating a distance in a feature vector space between a feature vector calculated from a feature of a keyword representing a dialog scene and a feature vector calculated from a feature of a keyword included in a remark of the user, and calculating the relevance (similarity) between the dialog scene and the remark of the user from the calculated distance.

Since an existing technique can be applied to the feature vectorization of text data, a detailed description thereof will be omitted. For example, text data of a user or a machine learning model can be converted into a feature vector using an existing embedded model such as Word2Vec, FastText, or GloVe or a transformer-type model such as BERT, RoBERTa, or GPT.

The recommendation unit 19 has a function of recommending (proposing) at least one of a dialog scene and a machine learning model included in the participants to a user from a feature of the user represented by the user management information 183 based on the recommendation criterion 188. The recommendation criterion 188 is a criterion for recommending at least one of the dialog scene and the machine learning model included in the participants to the user according to the feature of the user indicated by the user management information 183. The recommendation criterion 188 is given in advance by, for example, an administrator or the like of the dialog ability enhancement assistance device 10. The recommendation unit 19 displays the recommendation result on the display screen 21 of the terminal device 20.

For example, it is assumed that the evaluation result 186 indicating that the user who has participated in a dialog scene in which a machine learning model in which the progress of the discussion is generally fast and individual reactions are fast has participated is slow in response and cannot keep up with the discussion judging from the content of the user's remark is obtained. In this case, the recommendation unit 19 makes the discussion proceed slower based on the feature of the user indicated by the user management information 183 reflecting the evaluation result 186 described above, and recommends a combination of machine learning models in which individual reactions are slower as participants in the dialog. On the contrary, there is a case where the evaluation result 186 indicating that the user who has participated in the dialog scene in which the machine learning model in which the progress of the discussion is generally slow and the individual reactions are slow has participated is quick in response and can cope with a faster discussion judging from the content of the user's remark is obtained. In this case, the recommendation unit 19 makes the discussion proceed faster based on the feature of the user indicated by the user management information 183 reflecting the evaluation result 186 described above, and recommends a combination of machine learning models in which individual reactions are faster as participants in the dialog.

It is assumed that an evaluation result 186 indicating that the user who has participated in a dialog scene in which a machine learning model with high expertise with respect to a certain technical area has participated has few remarks and does not sufficiently understand the technical content being discussed judging from the remarks of the user is obtained. In this case, the recommendation unit 19 recommends, based on the feature of the user indicated by the user management information 183 reflecting the evaluation result 186 described above, a combination of machine learning models with slightly lower expertise regarding the technical area as participants in the dialog. In contrast, it is assumed that an evaluation result 186 indicating that a user who has participated in a dialog scene in which a machine learning model with less expertise in a certain technical area has participated can cope with a discussion with higher expertise judging from the content of the user's remark is obtained. In this case, the recommendation unit 19 recommends, based on the feature of the user indicated by the user management information 183 reflecting the evaluation result 186 described above, a combination of machine learning models with higher expertise regarding the technical area as participants in the dialog.

As described above, the recommendation unit 19 recommends, to the user, a combination of machine learning models capable of performing a dialog matching the dialog ability of the user as participants in the dialog. That is, the recommendation criterion 188 associates the dialog ability of the user with the dialog ability of the machine learning model.

The recommendation criterion 188 may be a criterion for recommending at least one of the dialog scene and the machine learning model included in the participants to the user according to a situation in which the feature of the user changes with a lapse of time. In this case, the evaluation unit 14 manages the user management information 183 indicating a feature of the user in time series. Then, in this case, the recommendation unit 19 recommends at least one of a combination of machine learning models capable of performing a dialog according to a dialog scene and the dialog ability of the user as participants in the dialog, in consideration of the fact that the dialog ability is gradually improved by the use of the dialog ability enhancement assistance device 10 by the user.

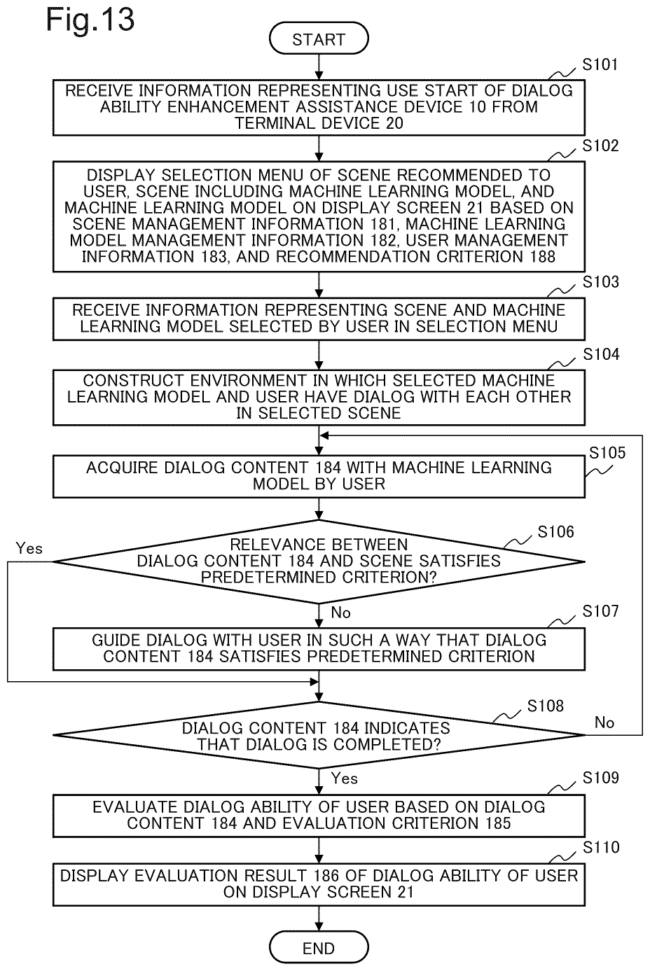

Next, an operation (processing) of the dialog ability enhancement assistance device 10 according to the present disclosure will be described in detail with reference to a flowchart of FIG. 13.

The reception unit 11 receives, from the terminal device 20, information indicating the start of use of the dialog ability enhancement assistance device 10, the information being input via an input operation on the terminal device 20 by the user (step S101). Based on the scene management information 181, the machine learning model management information 182, the user management information 183, and the recommendation criterion 188, the recommendation unit 19 displays the selection menu of a dialog scene and a machine learning model, including a dialog scene and a machine learning model to be recommended to the user on the display screen 21 (step S102).

The reception unit 11 receives information indicating the dialog scene and the machine learning model selected by the user in the selection menu (step S103). The construction unit 12 constructs an environment in which the selected machine learning model and the user have a dialog in the dialog scene selected by the user (step S104). The acquisition unit 13 acquires the dialog content 184 with the machine learning model by the user, the dialog being performed in the environment constructed by the construction unit 12 (step S105).

When the relevance between the dialog content 184 and the dialog scene satisfies the predetermined criterion (Yes in step S106), the process proceeds to step S108. In a case where the relevance between the dialog content 184 and the dialog scene does not satisfy the predetermined criterion (No in step S106), the machine learning model participating in the dialog guides the dialog with the user in such a way that the dialog content 184 satisfies the predetermined criterion (step S107).

When the dialog content 184 does not indicate that the dialog is completed (that is, it indicates that the dialog is being continued) (No in step S108), the process returns to step S105. In a case where the dialog content 184 indicates that the dialog is completed (No in step S108), the evaluation unit 14 evaluates the dialog ability of the user based on the dialog content 184 and the evaluation criterion 185 (step S109). The presentation unit 15 displays the evaluation result 186 of the dialog ability of the user on the display screen 21 of the terminal device 20 (step S110), and the entire process ends.

The dialog ability enhancement assistance device 10 according to the present disclosure can support enhancement of the dialog ability of the user assuming various dialog scenes. The reason is that the dialog ability enhancement assistance device 10 constructs an environment in which participants including the user and one or more machine learning models have a dialog in various scenes, evaluates the dialog ability of the user from the dialog content, and presents the evaluation result to the user.

Hereinafter, effects achieved by the dialog ability enhancement assistance device 10 according to the present disclosure will be described in detail.

For example, persons having a developmental disorder cannot have a dialog (communication) with another person well in daily life, and many of them are suffering from the developmental disorder. There is a medical care support system called an ABA Integrated Program for Autism spectrum disorder (AI-PAC) for people with developmental disorders, but since the AI-PAC focuses on a function of recommending teaching materials, it is often unable to be used in practice of an actual dialog and various scenes faced by people with developmental disorders in daily life. Not only a person having a developmental disorder but also a healthy person may suffer a disadvantage due to failure in dialog with another person in various scenes in daily life. In order to solve such a problem, it is required to support the enhancement of the dialog ability of the user assuming various dialog scenes.

In view of such a problem, the dialog ability enhancement assistance device 10 according to the present disclosure receives information for selecting a scene where participants including the user and one or more machine learning models have a dialog with each other and the machine learning models included in the participants. The dialog ability enhancement assistance device 10 constructs an environment in which the participants have a dialog with each other in the selected scene. The dialog ability enhancement assistance device 10 acquires the dialog content 184 between the user and the machine learning models in the environment. The dialog ability enhancement assistance device 10 evaluates the dialog ability of the user from the acquired dialog content 184 based on the evaluation criterion 185 for evaluating the dialog ability according to the dialog content 184. Then, the dialog ability enhancement assistance device 10 presents the evaluation result 186 of the dialog ability to the user. That is, the dialog ability enhancement assistance device 10 can support the enhancement of the dialog ability of the user assuming various dialog scenes by providing the user with an environment in which the dialog with the machine learning model assuming various dialog scenes is performed and presenting (feeding back) the evaluation result of the dialog ability of the user based on the dialog content to the user.

The dialog ability enhancement assistance device 10 according to the present disclosure generates a dialog scene from the user management information 183 indicating a feature of the user based on the scene generation criterion 187 for generating a dialog scene according to a feature of the user. As a result, the dialog ability enhancement assistance device 10 generates the scene of the dialog to be learned according to the feature of the user, so that it is possible to reliably support the enhancement of the dialog ability of the user assuming various dialog scenes.

The dialog ability enhancement assistance device 10 according to the present disclosure acquires the user management information 183 indicating the feature of the user including the preference of the user from the dialog content 184. As a result, the dialog ability enhancement assistance device 10 can manage a feature of the user with high accuracy, and thus can reliably support the enhancement of the dialog ability of the user assuming various dialog scenes.

The dialog ability enhancement assistance device 10 according to the present disclosure trains a machine learning model that participates in a dialog by learning words and actions of a real or fictitious character. As a result, the dialog ability enhancement assistance device 10 can efficiently generate a machine learning model having various features.

The dialog ability enhancement assistance device 10 according to the present disclosure includes, as a function of the machine learning model, a function of determining whether the relevance between the dialog content 184 and the dialog scene satisfies a predetermined criterion, and guiding the dialog with the user in such a way that the dialog content 184 satisfies the predetermined criterion in a case where the relevance does not satisfy the predetermined criterion. That is, since the dialog ability enhancement assistance device 10 generates the machine learning model having the function of promoting the dialog in such a way that the content of the dialog does not diverge, it is possible to reliably support the enhancement of the dialog ability of the user assuming various dialog scenes.

The dialog ability enhancement assistance device 10 according to the present disclosure recommends at least one of the dialog scene and the machine learning model participating in the dialog to the user from the feature of the user based on the recommendation criterion 188 for recommending at least one of the dialog scene and the machine learning model participating in the dialog to the user according to the feature of the user. As a result, since the user can appropriately perform learning for enhancing the dialog ability, the dialog ability enhancement assistance device 10 can reliably support the enhancement of the dialog ability of the user assuming various dialog scenes.

The dialog ability enhancement assistance device 10 according to the present disclosure may use the recommendation criterion 188 for managing the information indicating a feature of the user in time series, and recommending at least one of the dialog scene and the machine learning model included in the participants to the user according to the situation in which a feature of the user change with a lapse of time. In this case, the dialog ability enhancement assistance device 10 recommends at least one of the dialog scene and the machine learning model included in the participants to the user from the situation in which the feature of the user changes with a lapse of time. That is, the dialog ability enhancement assistance device 10 recommends the dialog scene and the machine learning model included in the participants in consideration of the fact that the dialog ability of the user is enhanced with a lapse of time as the user accumulates the dialog learning, and thus, it is possible to reliably support the enhancement of the dialog ability of the user assuming various dialog scenes.

The dialog ability enhancement assistance device 10 according to the present disclosure may notify, for example, a guardian and a supporter of a user having a developmental disorder of the evaluation result 186.

### Second Example Embodiment

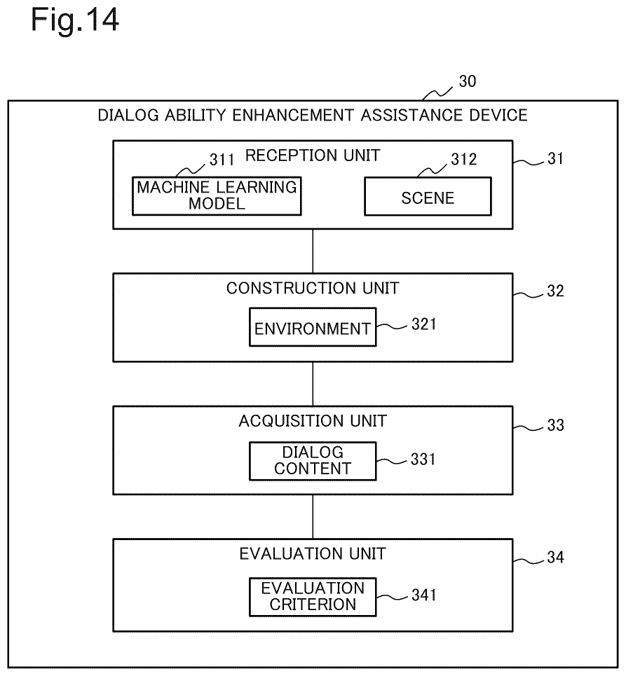

FIG. 14 is a block diagram illustrating a configuration of a dialog ability enhancement assistance device 30 according to the present disclosure. The dialog ability enhancement assistance device 30 includes a reception unit 31, a construction unit 32, an acquisition unit 33, and an evaluation unit 34. The reception unit 31, the construction unit 32, the acquisition unit 33, and the evaluation unit 34 are examples of a reception means, a construction means, an acquisition means, and an evaluation means, respectively.

The reception unit 31 receives information for selecting a scene 312 in which participants including the user and one or more machine learning models 311 have a dialog with each other and the machine learning models 311 included in the participants. The machine learning model 311 is, for example, a machine learning model similar to the machine learning model managed by the machine learning model management information 182 of the dialog ability enhancement assistance device 10. The scene 312 is, for example, a scene similar to the scene managed by the scene management information 181 of the dialog ability enhancement assistance device 10. For example, the reception unit 31 operates as in the reception unit 11 of the dialog ability enhancement assistance device 10.

The construction unit 32 constructs an environment 321 in which the participants have a dialog with each other in the selected scene 312. The environment 321 is, for example, an environment similar to the dialog environment constructed by the construction unit 12 of the dialog ability enhancement assistance device 10. For example, the construction unit 32 operates as in the construction unit 12 of the dialog ability enhancement assistance device 10.

The acquisition unit 33 acquires dialog content 331 between the user and the machine learning models 311 in the environment 321. The dialog content 331 is, for example, information similar to the dialog content 184 of the dialog ability enhancement assistance device 10. The acquisition unit 33 operates as in, for example, the acquisition unit 13 of the dialog ability enhancement assistance device 10.

The evaluation unit 34 evaluates the dialog ability of the user from the acquired dialog content 331 based on an evaluation criterion 341 for evaluating the dialog ability according to the dialog content 331. The evaluation criterion 341 is, for example, a criterion similar to the evaluation criterion 185 of the dialog ability enhancement assistance device 10. The evaluation unit 34 operates as in the evaluation unit 14 of the dialog ability enhancement assistance device 10, for example.

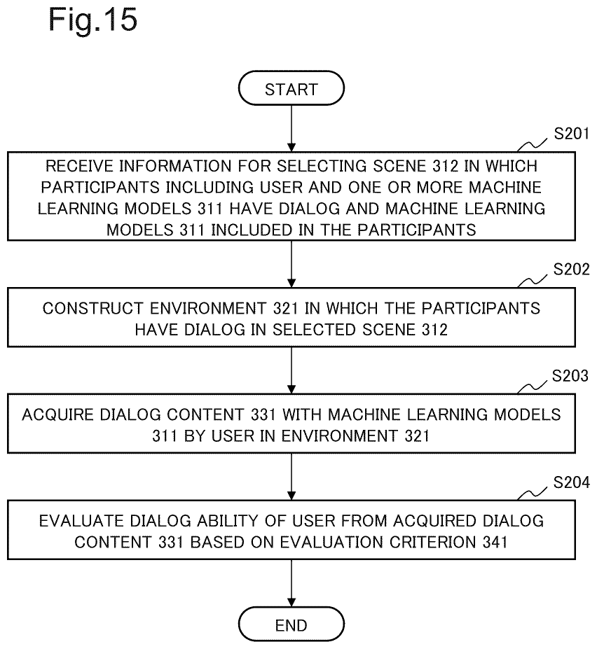

Next, an operation (processing) of the dialog ability enhancement assistance device 30 according to the present disclosure will be described in detail with reference to a flowchart of FIG. 15.

The reception unit 31 receives information for selecting the scene 312 in which participants including a user and one or more machine learning models 311 have a dialog with each other, and the machine learning models 311 included in the participants (step S201). The construction unit 32 constructs the environment 321 in which the participants have a dialog with each other in the selected scene 312 (step S202).

The acquisition unit 33 acquires the dialog content 331 between the user and the machine learning models 311 in the environment 321 (step S203). The evaluation unit 34 evaluates the dialog ability of the user from the acquired dialog content 331 based on the evaluation criterion 341 (step S204), and the entire process ends.

The dialog ability enhancement assistance device 30 according to the present disclosure can support enhancement of the dialog ability of the user assuming various scenes. The reason is that the dialog ability enhancement assistance device 30 constructs an environment in which participants including the user and one or more machine learning models have a dialog in various scenes, evaluates the dialog ability of the user from the dialog content, and presents the evaluation result to the user.

### Hardware Configuration Example

Each unit in the dialog ability enhancement assistance devices 10 and 30 device illustrated in FIGS. 1 and 14 in each of the above-described example embodiments can be achieved by dedicated hardware (HW) (electronic circuit). In FIGS. 1 and 8, at least the following configuration can be regarded as a function (processing) unit (software module) of a software program including an instruction executed by a processor.
Reception units 11 and 31,
Construction units 12 and 32,
Acquisition units 13 and 33,
Evaluation units 14 and 34,
Presentation unit 15,
Scene generation unit 16,
Machine learning model generation unit 17,
Recommendation unit 19,
Storage control function in the storage unit 18.

The division of each unit illustrated in these drawings is a configuration for convenience of description, and various configurations can be assumed at the time of implementation. An example of a hardware environment in this case will be described with reference to FIG. 16.

FIG. 16 is a diagram exemplarily describing a configuration of the information processing device 900 (computer) capable of achieving the dialog ability enhancement assistance device according to the present disclosure. That is, FIG. 16 illustrates a configuration of a computer (information processing device) capable of achieving the dialog ability enhancement assistance device illustrated in FIGS. 1 and 14, and illustrates a hardware environment capable of achieving each function in the above-described example embodiment. However, each unit in the dialog ability enhancement assistance device described above may be provided in a plurality of information processing devices 900 in a distributed manner, or at least some functions thereof may be provided in a server or the like constituting a cloud computing environment.

The information processing device 900 illustrated in FIG. 10 includes the following components as constituent elements.
Central processing unit (CPU) 901,
Read only memory (ROM) 902,
Random access memory (RAM) 903,
Hard disk (storage unit) 904,
Communication interface 905,
Bus 906 (communication line),
Reader/writer 908 capable of reading and writing data stored in a non-transitory recording medium 907 such as a compact disc read only memory (CD-ROM),
Input/output interface 909 such as a monitor, a speaker, and a keyboard.

That is, the information processing device 900 including the above-described components is a general computer to which these components are connected via the bus 906. The information processing device 900 may include a plurality of CPUs 901 or may include a CPU 901 configured by a plurality of cores. The information processing device 900 may not include part of the above-described configuration.

The processor used by the information processing device 900 is not limited to the CPU. For example, the processor may be a micro processing unit (MPU), a digital signal processor (DSP), a tensor processing unit (TPU), or a graphics processing unit (GPU). Alternatively, the processor may be a field programmable gate array (FPGA), an application specific integrated circuit (ASIC), or the like. The processor executes various kinds of programs including an operating system (OS).

The present disclosure described using the above-described example embodiment as an example supplies a computer program capable of achieving the following functions to the information processing device 900 illustrated in FIG. 16. The function is the above-described configuration in the block configuration diagram (FIGS. 1 and 14) referred to in the description of the example embodiment or the function of the flowchart (FIGS. 13 and 15). Thereafter, the present disclosure is achieved by reading, interpreting, and executing the computer program on the CPU 901 of the hardware. The computer program supplied into the device may be stored in a readable/writable volatile memory (RAM 903) or a non-volatile storage device such as the ROM 902 or the hard disk 904.

In the above case, a general procedure can be used at present as a method of supplying the computer program into the hardware. Examples of the procedure include a method of installing the program in the device via various non-transitory recording media 907 such as a CD-ROM, a method of downloading the program from the outside via a communication line such as the Internet, and the like. In such a case, the present disclosure can be understood to be configured by a code constituting the computer program or the non-transitory recording medium 907 storing the code.

The present disclosure is described above using the above-described example embodiments as exemplary examples. However, the present disclosure is not limited to the above-described example embodiments. That is, the present disclosure can have various aspects that can be understood by the those of ordinary skill in the art in the scope of the present disclosure.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

### Supplementary Note

Part or all of each example embodiment described above can also be described as the following Supplementary Notes. However, the present disclosure exemplarily described by the above-described example embodiments is not limited to the following.

### (Supplementary Note 1)

A dialog ability enhancement assistance device including
a reception means for receiving information for selecting a scene in which participants including a user and one or more machine learning models have a dialog with each other, and the machine learning models included in the participants,
a construction means for constructing an environment in which the participants have a dialog with each other in the selected scene,
an acquisition means for acquiring dialog content between the user and the machine learning models in the environment, and
an evaluation means for evaluating, based on an evaluation criterion for evaluating a dialog ability according to the dialog content, the dialog ability of the user from the acquired dialog content.

### (Supplementary Note 2)

The dialog ability enhancement assistance device according to Supplementary Note 1, further including
a scene generation means for generating the scene from information indicating a feature of the user based on a scene generation criterion for generating the scene according to the feature of the user.

### (Supplementary Note 3)

The dialog ability enhancement assistance device according to Supplementary Note 2, wherein
the information indicating the feature of the user indicates at least one of an age, a gender, an occupation, a preference, a personality, a record of the dialog content, and a record of an evaluation result of the dialog ability of the user.

### (Supplementary Note 4)

The dialog ability enhancement assistance device according to Supplementary Note 2 or 3, wherein
the acquisition means acquires information indicating a feature of the user including a preference of the user from the dialog content.

### (Supplementary Note 5)

The dialog ability enhancement assistance device according to any one of Supplementary Notes 1 to 4, further including
a machine learning model generation means for training the machine learning model by learning words and actions of a real or fictitious character.

### (Supplementary Note 6)

The dialog ability enhancement assistance device according to Supplementary Note 5, wherein
the machine learning model generation means includes, as a function of the machine learning model, a function of determining whether relevance between the dialog content and the scene satisfies a predetermined criterion and guiding a dialog with the user in such a way that the dialog content satisfies the predetermined criterion when the relevance does not satisfy the predetermined criterion.

### (Supplementary Note 7)

The dialog ability enhancement assistance device according to any one of Supplementary Notes 1 to 6, further including
a recommendation means for recommending at least one of the scene and the machine learning models to the user from a feature of the user based on a recommendation criterion for recommending at least one of the scene and the machine learning models to the user according to the feature of the user.

### (Supplementary Note 8)

The dialog ability enhancement assistance device according to Supplementary Note 7, wherein
the evaluation means manages information indicating the feature of the user in time series, and
the recommendation means recommends at least one of the scene and the machine learning models to the user from a situation in which the feature of the user changes with a lapse of time based on the recommendation criterion for recommending at least one of the scene and the machine learning models to the user according to a situation in which the feature of the user changes with the lapse of time.

### (Supplementary Note 9)

A dialog ability enhancement assistance method executed by an information processing device, the method including
receiving information for selecting a scene in which participants including a user and one or more machine learning models have a dialog with each other, and the machine learning models included in the participants,
constructing an environment in which the participants have a dialog with each other in the selected scene,
acquiring dialog content between the user and the machine learning models in the environment, and
evaluating, based on an evaluation criterion for evaluating a dialog ability according to the dialog content, the dialog ability of the user from the acquired dialog content.

### (Supplementary Note 10)

The dialog ability enhancement assistance method according to Supplementary Note 9, further including
generating the scene from information indicating a feature of the user based on a scene generation criterion for generating the scene according to the feature of the user.

### (Supplementary Note 11)

The dialog ability enhancement assistance method according to Supplementary Note 10, wherein
the information indicating the feature of the user indicates at least one of an age, a gender, an occupation, a preference, a personality, a record of the dialog content, and a record of an evaluation result of the dialog ability of the user.

### (Supplementary Note 12)

The dialog ability enhancement assistance method according to Supplementary Note 10 or Supplementary Note 11, further including
acquiring information indicating a feature of the user including a preference of the user from the dialog content.

### (Supplementary Note 13)

The dialog ability enhancement assistance method according to any one of Supplementary Notes 9 to 12, further including
training the machine learning model by learning words and actions of a real or fictitious character.

### (Supplementary Note 14)

The dialog ability enhancement assistance method according to Supplementary Note 13, further including
including, as a function of the machine learning model, a function of determining whether relevance between the dialog content and the scene satisfies a predetermined criterion and guiding a dialog with the user in such a way that the dialog content satisfies the predetermined criterion when the relevance does not satisfy the predetermined criterion.

### (Supplementary Note 15)

The dialog ability enhancement assistance method according to any one of Supplementary Notes 9 to 14, further including
recommending at least one of the scene and the machine learning models to the user from a feature of the user based on a recommendation criterion for recommending at least one of the scene and the machine learning models to the user according to the feature of the user.

### (Supplementary Note 16)

The dialog ability enhancement assistance method according to Supplementary Note 15, further including
managing information indicating the feature of the user in time series, and
recommending at least one of the scene and the machine learning models to the user from a situation in which the feature of the user changes with a lapse of time based on the recommendation criterion for recommending at least one of the scene and the machine learning models to the user according to a situation in which the feature of the user changes with the lapse of time.

### (Supplementary Note 17)

A non-transitory recording medium recording a computer program for causing a computer to execute:
receiving information for selecting a scene in which participants including a user and one or more machine learning models have a dialog with each other, and the machine learning models included in the participants,
constructing an environment in which the participants have a dialog with each other in the selected scene,
acquiring dialog content between the user and the machine learning models in the environment, and
evaluating, based on an evaluation criterion for evaluating a dialog ability according to the dialog content, the dialog ability of the user from the acquired dialog content.

### (Supplementary Note 18)

The non-transitory recording medium according to Supplementary Note 17, recording a computer program for causing the computer to further execute:
generating the scene from information indicating the feature of the user based on a scene generation criterion for generating the scene according to the feature of the user.

### (Supplementary Note 19)

The non-transitory recording medium according to Supplementary Note 18, wherein
the information indicating the feature of the user indicates at least one of an age, a gender, an occupation, a preference, a personality, a record of the dialog content, and a record of an evaluation result of the dialog ability of the user.

### (Supplementary Note 20)

The non-transitory recording medium according to Supplementary Note 18 or Supplementary Note 19, recording a computer program for causing the computer to further execute:
acquiring information indicating the feature of the user including a preference of the user from the dialog content.

### (Supplementary Note 21)

The non-transitory recording medium according to any one of Supplementary Notes 17 to 20, recording a computer program for causing the computer to further execute:
training the machine learning model by learning words and actions of a real or fictitious character.

### (Supplementary Note 22)

The non-transitory recording medium according to Supplementary Note 21, recording a computer program for causing the computer to further execute:
as a function of the machine learning model, a function of determining whether relevance between the dialog content and the scene satisfies a predetermined criterion and guiding a dialog with the user in such a way that the dialog content satisfies the predetermined criterion when the relevance does not satisfy the predetermined criterion.

### (Supplementary Note 23)

The non-transitory recording medium according to any one of Supplementary Notes 17 to 22, recording a computer program for causing the computer to further execute:
recommending at least one of the scene and the machine learning models to the user from a feature of the user based on a recommendation criterion for recommending at least one of the scene and the machine learning models to the user according to a feature of the user.

### (Supplementary Note 24)

The non-transitory recording medium according to Supplementary Note 23, recording a computer program for causing the computer to further execute:
managing information indicating a feature of the user in time series, and
recommending at least one of the scene and the machine learning models to the user from a situation in which a feature of the user changes with a lapse of time based on the recommendation criterion for recommending at least one of the scene and the machine learning models to the user according to a situation in which a feature of the user changes with a lapse of time.

1. A dialog ability enhancement assistance device comprising:
one or more memories storing instructions; and
one or more processors configured to execute the instructions to:
receive information for selecting a scene in which participants including a user and one or more machine learning models have a dialog with each other, and the machine learning models included in the participants;
construct an environment in which the participants have a dialog with each other in the selected scene;
acquire dialog content between the user and the machine learning models in the environment; and
evaluate, based on an evaluation criterion for evaluating a dialog ability according to the dialog content, the dialog ability of the user from the acquired dialog content.

2. The dialog ability enhancement assistance device according to claim 1, wherein the one or more processors are configured to further execute the instructions to: generate the scene from information indicating a feature of the user based on a scene generation criterion for generating the scene according to the feature of the user.

3. The dialog ability enhancement assistance device according to claim 2, wherein the information indicating the feature of the user indicates at least one of an age, a gender, an occupation, a preference, a personality, a record of the dialog content, and a record of an evaluation result of the dialog ability of the user.

4. The dialog ability enhancement assistance device according to claim 2, wherein the acquisition means acquires information indicating a feature of the user including a preference of the user from the dialog content.

5. The dialog ability enhancement assistance device according to claim 1, wherein the one or more processors are configured to further execute the instructions to: train the machine learning model by learning words and actions of a real or fictitious character.

6. The dialog ability enhancement assistance device according to claim 5, wherein the one or more processors are configured to further execute the instructions to: include, as a function of the machine learning model, a function of determining whether relevance between the dialog content and the scene satisfies a predetermined criterion and guiding a dialog with the user in such a way that the dialog content satisfies the predetermined criterion when the relevance does not satisfy the predetermined criterion.

7. The dialog ability enhancement assistance device according to claim 1, wherein the one or more processors are configured to further execute the instructions to: recommend at least one of the scene and the machine learning models to the user from a feature of the user based on a recommendation criterion for recommending at least one of the scene and the machine learning models to the user according to a feature of the user.

8. The dialog ability enhancement assistance device according to claim 7, wherein the one or more processors are configured to further execute the instructions to:
manage information indicating the feature of the user in time series; and
recommend at least one of the scene and the machine learning models to the user from a situation in which the feature of the user changes with a lapse of time based on the recommendation criterion for recommending at least one of the scene and the machine learning models to the user according to a situation in which the feature of the user changes with the lapse of time.

9. A dialog ability enhancement assistance method executed by an information processing device, the method comprising:
receiving information for selecting a scene in which participants including a user and one or more machine learning models have a dialog with each other, and the machine learning models included in the participants;
constructing an environment in which the participants have a dialog with each other in the selected scene;
acquiring dialog content between the user and the machine learning models in the environment; and
evaluating, based on an evaluation criterion for evaluating a dialog ability according to the dialog content, the dialog ability of the user from the acquired dialog content.

10. The dialog ability enhancement assistance method according to claim 9, the method further comprising:
generating the scene from information indicating a feature of the user based on a scene generation criterion for generating the scene according to the feature of the user.

11. The dialog ability enhancement assistance method according to claim 10, wherein
the information indicating the feature of the user indicates at least one of an age, a gender, an occupation, a preference, a personality, a record of the dialog content, and a record of an evaluation result of the dialog ability of the user.

12. The dialog ability enhancement assistance method according to claim 10, the method further comprising
acquiring information indicating a feature of the user including a preference of the user from the dialog content.

13. The dialog ability enhancement assistance method according to claim 9, the method further comprising
training the machine learning model by learning words and actions of a real or fictitious character.

14. The dialog ability enhancement assistance method according to claim 13, the method further comprising
including, as a function of the machine learning model, a function of determining whether relevance between the dialog content and the scene satisfies a predetermined criterion and guiding a dialog with the user in such a way that the dialog content satisfies the predetermined criterion when the relevance does not satisfy the predetermined criterion.

15. The dialog ability enhancement assistance method according to claim 9, the method further comprising
recommending at least one of the scene and the machine learning models to the user from a feature of the user based on a recommendation criterion for recommending at least one of the scene and the machine learning models to the user according to the feature of the user.

16. The dialog ability enhancement assistance method according to claim 15, the method further comprising:
managing information indicating the feature of the user in time series; and
recommending at least one of the scene and the machine learning models to the user from a situation in which the feature of the user changes with a lapse of time based on the recommendation criterion for recommending at least one of the scene and the machine learning models to the user according to a situation in which the feature of the user changes with the lapse of time.

17. A non-transitory recording medium recording a computer program for causing a computer to execute:
receiving information for selecting a scene in which participants including a user and one or more machine learning models have a dialog with each other, and the machine learning models included in the participants;
constructing an environment in which the participants have a dialog with each other in the selected scene;
acquiring dialog content between the user and the machine learning models in the environment; and
evaluating, based on an evaluation criterion for evaluating a dialog ability according to the dialog content, the dialog ability of the user from the acquired dialog content.

18. The non-transitory recording medium according to claim 17 recording a computer program for causing the computer to further execute:
generating the scene from information indicating the feature of the user based on a scene generation criterion for generating the scene according to the feature of the user.

19. The non-transitory recording medium according to claim 18, wherein
the information indicating the feature of the user indicates at least one of an age, a gender, an occupation, a preference, a personality, a record of the dialog content, and a record of an evaluation result of the dialog ability of the user.

20. The non-transitory recording medium according to claim 18, recording a computer program for causing the computer to further execute:
acquiring information indicating the feature of the user including a preference of the user from the dialog content.
